(19) United States
(12) Patent Application Publication
(10) Pub. No.: US 2009/0182689 A1
(43) Pub. Date: Jul. 16, 2009

(54) RULE-BASED DYNAMIC OPERATION EVALUATION

(75) Inventors: William P. Chiles, Seattle, WA (US); Robert E. Viehland, Redmond, WA (US); James J. Hugunin, Redmond, WA (US); Martin Maly, Redmond, WA (US)

Correspondence Address: MICROSOFT CORPORATION, ONE MICROSOFT WAY, REDMOND, WA, 98052, US

(73) Assignee: MICROSOFT CORPORATION, REDMOND, WA (US)

(21) Appl. No.: 12/014,734

(22) Filed: Jan. 15, 2008

(51) Int. Cl. G06F 15/18; G06N 5/02

(52) U.S. Cl. 706/12; 706/59; 706/60

(57) ABSTRACT

A computer program may involve a dynamic operation, which may specify one of many types of methods based on the conditions of the invocation during runtime, such as the parameters provided to the dynamic operation. The appropriate performance of the dynamic method may be achieved by analyzing the conditions of the invocation according to an evaluation rule set, the rules comprising conditions and an action to be performed if the conditions are satisfied. The evaluation rule set may also be reconfigured upon identifying a satisfied rule to facilitate a faster evaluation of the dynamic operation during a second and subsequent invocations.

### BACKGROUND

Computer programs are often written in a high-level programming language, such as C#, Java, Visual Basic, Python, etc., and are then translated into a machine-executable program comprising machine-level instructions to be executed and/or low-level instructions to be interpreted. As part of the translation, the computer program may be transformed into an abstract semantic tree, which represents one or more operations and the parameters provided thereto as a hierarchical, node-based tree structure, wherein some nodes comprise the names of operations (such as methods to be invoked) or conditional logic statements, and wherein leaf nodes comprise parameters provided to such operations or conditional logic statements specified in the parent nodes. An abstract semantic tree serves to represent the meaningful information in the text of a program as a data structure, without the formalisms of special parts of the text that are required when a program is represented in text form. One advantage of such a syntax tree is that a development environment may permit a user to choose among a set of programming languages in order to write a computer program. The development environment may then build the application by parsing the programming language with a language-specific parser to construct an abstract semantic tree. The abstract semantic tree so produced may be further processed (e.g., compiled into a partially or wholly compiled executable binary, or prepared for interpretive execution) and coupled with precompiled programming libraries and other modules, and such processing may be performed consistently with less impact due to the programming language of the source code. In this manner, a computer program written in any programming language may be prepared for execution with the same programmatic logic and utilizing the same programming libraries, and resulting in the same executable program and attendant behavior, as operationally equivalent programs written in other programming languages.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Contemporary programming languages often include expressions for dynamic operations, where an operation invoked in different circumstances may proceed in wholly different manners. As one example, many object-oriented programming languages permit the declaration of polymorphic methods, comprising two or more methods having the same function name but different numbers and/or types of parameters (e.g.: “int Process(int iParam1, int iParam2)” vs. “int Process(string strParam1, string strParam2, string strParam3)”.) As another example, Perl permits functions to have side-effects, wherein a function invoked in a first instance may produce a different behavior than a function invoked in a second instance, in case an environmental parameter is differently configured (e.g., an environmental variable may be set to different values to specify that the method should operate in different ways.)

A dynamic operation is not ambiguous—i.e., during an invocation, the dynamic operation may be evaluated in view of the relevant circumstances, such as the parameters specified during the dynamic operation—but it may be difficult to determine the behaviors that the dynamic operation is likely to exhibit prior to runtime, due to the varied and potentially large number of behaviors that may be invoked based on different circumstances. Accordingly, during runtime, a full evaluation of the circumstances and the possible behaviors is often performed for a particular invocation of the dynamic operation. The complexity of this analysis may involve a significant consumption of computing resources if fully performed for successive invocations, e.g., if the same invocation is performed multiple times through a loop. Moreover, this consumption may be unnecessary and may comprise an inefficiency, e.g., if most or all invocations of the dynamic operation occur under circumstances leading to one particular result (such as repeated invocation of the dynamic operation with the same set of parameter types.)

One technique for mitigating this inefficiency involves storing some details of analyses performed for preceding invocations of the dynamic operation, and utilizing these prior analyses during a subsequent invocation by migrating the analysis toward the results of the preceding analyses. For example, if the analysis performed during a first invocation involved a series of tests that led to a particular conclusion and an a resulting action, then during a second analysis, the tests that affirmatively led to the former conclusion may be performed first. If these tests succeed, then the same conclusion may be reached more quickly during the second invocation, thereby avoiding unnecessary tests and improving the efficiency of the dynamic operation evaluation. Moreover, the evaluation may be devised as a method configured to perform the tests of the evaluation encoding the rules of the evaluation, which may be emitted as code by an evaluation builder function, and recompiled upon adjusting the evaluation to account for new rules.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an example of several source programs compiled into an abstract semantic tree.

FIG. 2 is an example of an evaluation rule set that may be used to evaluate an invocation of a dynamic operation.

FIG. 3 is an example of a portion of another evaluation rule set that may be used to evaluate an invocation of a dynamic operation.

FIG. 4 is a flow diagram illustrating an exemplary method of executing an invocation of a dynamic operation.

FIG. 5 is a flow diagram illustrating an exemplary method of representing a dynamic operation.

FIG. 6 is an illustration of a rule template applied to generate a plurality of rules for use in similar evaluation rule sets.

FIG. 7 is a flow diagram illustrating another exemplary method of executing an invocation of a dynamic operation.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Computer programs are written in one or more of the many programming languages that may be available for a particular platform, such as a particular computing architecture or operating system. The various programming languages may present different language features, such as functional vs. object-oriented programming or strictly vs. dynamically typed objects. However, the programmatic logic and flow expressed for a program written in a first programming language may be very similar to the programmatic flow and logic for a program written in a second programming language, unaffected by the syntactic differences between the first and second programming languages. Moreover, many programming languages may provide interfaces to a particular programming library (such as an application programming interface, or API) hosted by the operating system or another program, and the invocation of the programming library through a first programming language may be very similar to the invocation of the programming library through a second programming language.

Based on the significant fungibility of such programming languages, a software development environment (such as a visual software design tool) may support multiple programming languages, and may permit the developer to select among the multiple programming languages for developing an application. While building a program, the development environment may first standardize the program to an abstract, language-independent representation of the programmatic flow expressed in the program. The abstract representation may then be further prepared for execution (e.g., partially or wholly compiled into an executable binary, written as an interpretable program or script, and operatively coupled with programming libraries referenced by the program) without regard to the syntactic particularities of the selected programming language. The standardization of such programs early in the build process permits the application of a significant portion of the build pipeline to any program, and therefore reduces the necessity of building language-specific compilers and linkers. Moreover, by separating the programming language text representation particularities from the underlaying programming logic at an early build stage while retaining the semantic particularities, the development environment may promote consistency and standardization among versions of a program written in various programming languages.

One language-independent representation of the programmatic logic is an abstract semantic tree, comprising a logical structure organized as a tree and containing the components of the computer program in a hierarchical manner. Many nodes of the tree represent operations, such as method invocations and mathematical operations, and the children of such nodes may represent the parameters of the operation; e.g., “x=1+2” may comprise an “=” node with child nodes “x”, “1”, and “2”. Conditional logic may also be expressed as a set of nodes, with the operands of the condition test represented as child nodes; e.g., “if x, execute Method1; else, execute Method 2” may comprise an “if” node with a first child “x”, a second child “Method1”, and a third child “Method2”. Logic may also be nested; e.g., an “if” node may be a child node of another “if” node, and a “while” block may have a child node representing the while test and another child node representing the operations to be performed per iteration of the while test. A development environment may feature an abstract semantic tree generation component, and the build process for a program may involve generating an abstract semantic tree representation of the program at an early stage of the build process, upon which the remainder of the build process (compiling, linking, etc.) may operate. This process facilitates the building of an application in a standardized manner based on the underlaying programmatic logic, and without overly accounting for the syntactic constructs of the high-level programming language chosen by the developer to express the program logic.

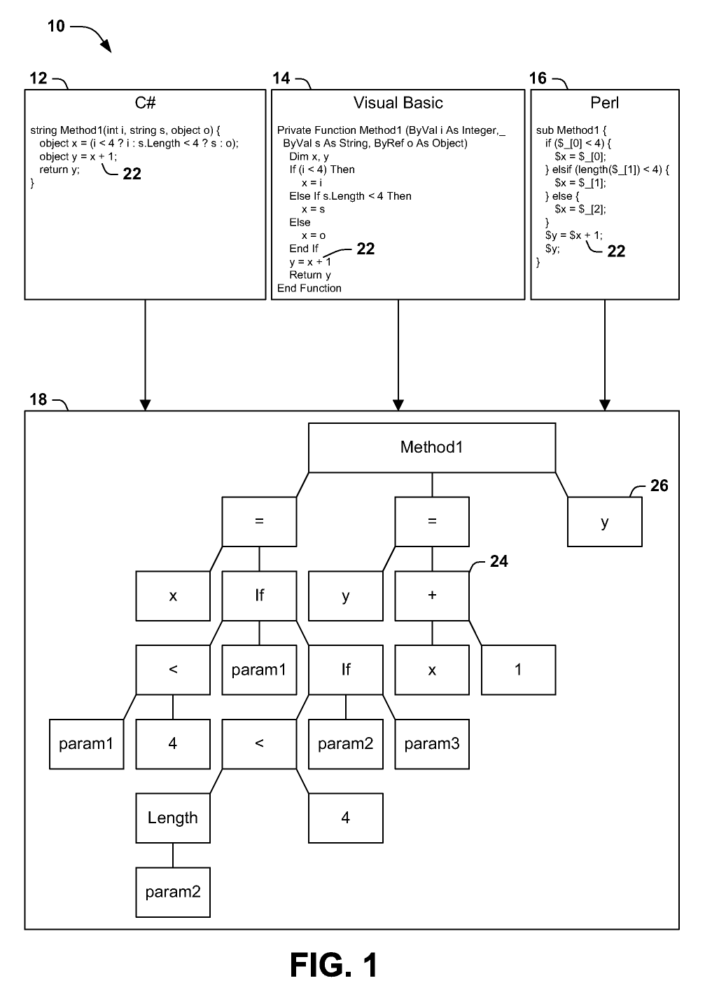

FIG. 1 illustrates an example 10 of an abstract semantic tree 18 generated from any of three source programs: a first source program 12 comprising a C# program, a second source program 14 comprising a Visual Basic program, and a third source program 16 comprising a Perl script. These programs each express some programming logic for a function called “Method1” that accepts a few parameters, manipulates the values contained therein, and returns a result. While the syntactic differences of each programming language are readily apparent, the programmatic logic and flow of each program is the same, calling for the same series of tests and mathematical invocations to arrive at the value to be returned by the function. Accordingly, each program may be compiled into an abstract semantic tree 18 representing the flow of conditional logic and operations expressed by the program. Moreover, the source programs all result in the same abstract semantic tree 18, regardless of the syntax in which the program was expressed. The abstract semantic tree 18 generated from any such program may then be further processed (e.g., partial or complete compilation, writing in an interpretable format, linking to other libraries, etc.) to produce an executable program, such as by iterating over the nodes of the abstract semantic tree 18 and expressing lower-level instructions for performing an operation specified by each node.

One feature that may not be apparent at first glance from the example 10 of FIG. 1 is the difficulty that may arise from dynamic operations. Many instructions give rise to involve static operations, wherein the circumstances of the invocation are well-defined and only one interpretation is possible in the context of the instruction. For instance, ‘string s=“Hello World”’ can only be interpreted one way in most languages, and the corresponding node of an abstract semantic tree may only be associated with one operation involving the String constructor and assignment functions. However, other instructions may give rise to dynamic operations, which may involve a first operation if invoked in a first circumstance, and a second operation if invoked in a second circumstance, etc. An example of such a dynamic operation is a polymorphic function in an object-oriented programming language, in which two methods may be written having the same name but different types of parameters, such that the choice of which method to invoke may depend on the parameters provided during the invocation. A parser iterating over the nodes of the abstract semantic tree 18 to prepare low-level instructions may encounter an ambiguity upon encountering a node in an abstract semantic tree specifying an operation calling these methods by name. If the types of the parameters (e.g., the child nodes of such a node) are not expressly and invariantly defined as part of the abstract semantic tree 18, then the parser may be unable to indicate which method to invoke, particularly if different sets of parameters may be provided in different iterations of the invocation. The decision may have to be made during runtime, when specific parameters are specified with the method at the moment of invocation.

The abstract semantic tree 18 of FIG. 1 includes a node comprising a dynamic operation, in the form of the “+” operator node 24. As may be apparent from the programming logic of the first source program 12, the second source program 14, and the third source program 16, the operation invoked by each instruction 22 corresponding to the “+” operator node 24 may involve different types of operations. If the first parameter comprises an integer less than four, then the “+” operator node 24 invokes a mathematical add operation of the integer parameter and the number 1. However, if the first parameter is not an integer less than four, then the program examines the length of the string integer; if this length is less than four, then the “+” operator node 24 involves a string concatenation operation that tacks on the number 1 to the end of the string (e.g., “Fig” becomes “FIG. 1”). If neither condition is satisfied, then the “=” operator node 24 attempts to invoke an add operation on whatever type of object is provided as the third parameter. The third parameter may comprise (e.g.) an integer involving a numeric add operation, a string involving a concatenation operation, a DateTime object involving a date manipulation add one day (or one second) to a date or time representation, an output file to which a byte comprising the value 0×00000001 is to be written, etc. Indeed, the third parameter may even comprise an item type that does not support a “+” operator, such as a representation of a database for which the “+” semantic is inapplicable.

Due to the ambiguity of the dynamic operation prior to the runtime invocation of the operation, processing such a dynamic operation node in an abstract semantic tree may be difficult, and the final interpretation of the dynamic operation may be deferred until the moment of invocation during runtime. Upon invocation of the dynamic operation, a runtime module that is hosting the compiled program, or an interpreter that is interpretively executing the program, may perform an analysis of the circumstances of the invocation (in this case, an assessment of the nature of the x parameter supplied to the “+” operator node 24) to determine the function or instructions to be invoked for the dynamic operation. However, the circumstances of the dynamic operation may change between two invocations—i.e., the x parameter may comprise an integer during a first invocation, but may comprise a string during a second invocation—so the runtime module or interpreter may have to perform the analysis again upon a second invocation of the dynamic operation.

The repeated analysis of the conditions under which a dynamic operation is invoked may impose a significant performance cost on the computing environment. For example, if the dynamic operation resides in a short but frequently iterated function, such as a short for loop invoked a thousand times, the repeated analysis of the parameters may significantly encumber the operation of the program and slow the computing environment. Moreover, such repeated analysis may be unnecessary if the circumstances do not change between invocations. For example, if Method1 is invoked with the same parameters during a short programming loop having many iterations, then the repeated analysis of the “+” operator node 24 may significantly diminish the performance of the program, despite reaching the same conclusion for each invocation of the Method1 method in the programming loop. However, it may be difficult to reduce this inefficiency prior to runtime, because it may be difficult to determine when the method might be invoked repeatedly with the same parameters and when it might be invoked with a different set of parameters, leading to a different analysis. As a result, languages that broadly support dynamic operations may incur a significant performance penalty due to the frequent and complicated analysis of such dynamic operations.

One technique for reducing the performance penalty involves storing the results of an analysis of a dynamic operation for use in the next iteration. For example, a dynamic operation invoked repeatedly in a particular location of a program is often invoked under the same circumstances and leads to the same resulting action. If the conditions giving rise to a result in an analysis of a first invocation of a dynamic operation can be stored, then upon a second invocation of the same dynamic operation, the computer system might directly test the same conditions, and may take the associated action if the conditions prove to be the same during the second invocation as during the first invocation. The analysis might therefore skip a significant part of the analysis that is unlikely to be relevant in light of the high probability of a similar invocation. This technique may therefore expedite the evaluation of the dynamic operation, without specifying or determining prior to the first runtime invocation how the dynamic operation might be used, and while preserving the dynamic aspect of the operation in case the circumstances of its invocation change.

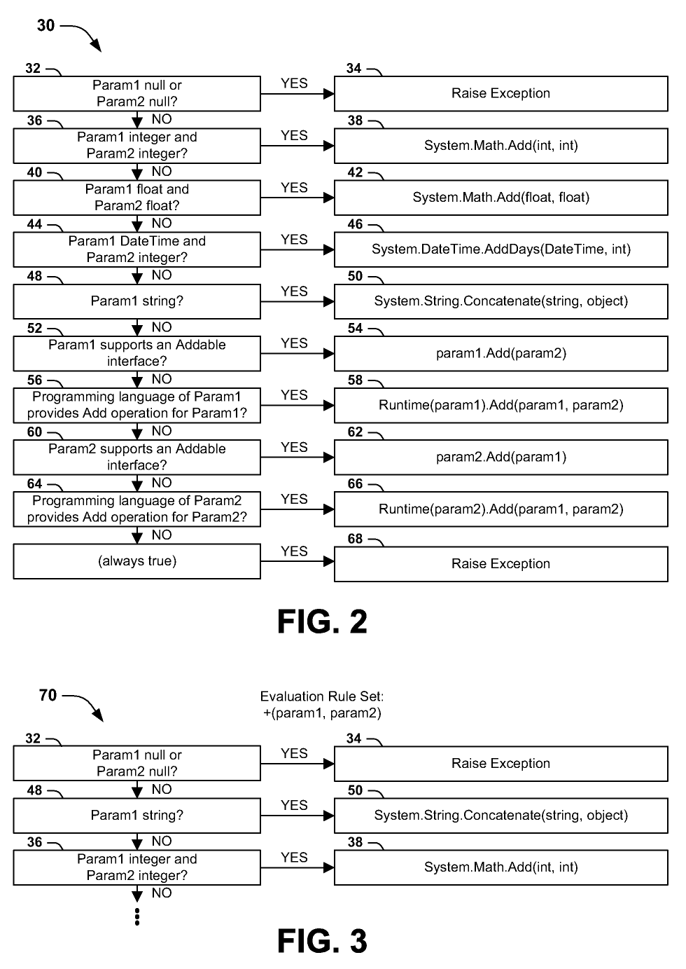

This technique may be applied through the generation and use of an evaluation rule set associated with the dynamic operation. FIG. 2 illustrates an exemplary evaluation rule set 30 that endeavors to determine how to parse a dynamic operation comprising a “+” operator applied to two parameters. This dynamic operation is determined by the circumstances of the parameters, which in this case are of unknown object types. Other dynamic operations may involve other circumstances, such as runtime or environmental parameters that may alter the evaluation and the actions invoked by the dynamic operation. Although it may be difficult to determine the object types that will be provided as parameters to a dynamic operation prior to invocation, the object types will be analyzable upon invocation according to the exemplary evaluation rule set 30 to determine, without ambiguity, which action is to be used to perform the dynamic operation.

The exemplary evaluation rule set 30 of FIG. 2 comprises a series of rules, where each rule comprises a set of conditions and an action to be taken (e.g., a method to be invoked, or an exception to be raised) if the conditions are satisfied. In this exemplary evaluation rule set 30, the rules are evaluated in sequence, such that if the first rule conditions 32 are satisfied, the first rule action 34 is performed, and if the first rule conditions 32 are not satisfied, the second rule conditions 36 are next evaluated. The dynamic nature of the “+” operation is evident in the variety of actions that may be performed to fulfill the operation in different circumstances, including an integer add operation 38 and a floating-point add operation 42, a date and time adjustment operation 46, and a string concatenation operation 50. Moreover, the conditions tested by the exemplary evaluation rule set 30 are not limited to inquiries as to the object types. For example, the sixth rule conditions 52 inquire whether the first parameter supports an Addable interface, and if so, the sixth rule action 54 indicates that an Add function of the first parameter should be invoked. As another example, if none of the more common operations for adding to the first parameter apply and the object cannot provide an adding function, then the evaluation may inquire with the runtime support of the language that produced the first parameter, in case the runtime can analyze the first parameter and recommend a suitable Add function. Accordingly, in discerning the proper manner of fulfilling a dynamic operation, the evaluation rule set may utilize a wide variety of criteria in the conditional evaluation of the circumstances.

As illustrated by the exemplary evaluation rule set 30 of FIG. 2, the evaluation of a dynamic operation may entail a complex analysis. Moreover, if a particular dynamic operation (e.g., an instance of the “param1+param2” function at a particular position in a source code) is repeatedly invoked with the same circumstances, then some portions of the analysis may be unnecessary. For instance, if a program uses the “+” operator to concatenate to a string in a repeated manner, such as a loop, then each iteration of the exemplary evaluation rule set 30 fruitlessly tests whether the string is null (according to the first rule conditions 32), an integer (according to the second rule conditions 36), a floating-point number (according to the third rule conditions 40), or a DateTime value(according to the fourth rule conditions 44) before arriving at the conditional test that has been satisfied in many prior iterations of the dynamic operation.

Instead, upon identifying a satisfied rule (i.e., a rule in which the conditions of the rule are satisfied), the evaluation rule set may be updated to reflect the recent satisfaction of the rule, such as by increasing the priority of the satisfied rule within the series of rules to promote an earlier evaluation during the next invocation in case the same circumstances and analysis apply. FIG. 3 illustrates an updated exemplary evaluation rule set 70, which may be associated with an instance of a dynamic operation (such as a “+” operation at a particular position in the source code) after the dynamic operation is first invoked with a string parameter, resulting in a satisfaction of the fifth rule conditions 48 and the performance of the string concatenation operation 50. The updated exemplary evaluation rule set 70 reflects this recent invocation by moving the fifth rule up in the rule series to become the second rule evaluated (just after the first rule that ensures that neither parameter comprises a null value.) If the dynamic operation is subsequently invoked with string parameters, the evaluation of the dynamic operation according to the updated exemplary evaluation rule set 70 will be faster than the evaluation of the exemplary evaluation rule set 30, which may produce improved computing performance for the computer program (particularly if the dynamic operation is invoked in the same conditions many times, such as in a loop having many iterations.)

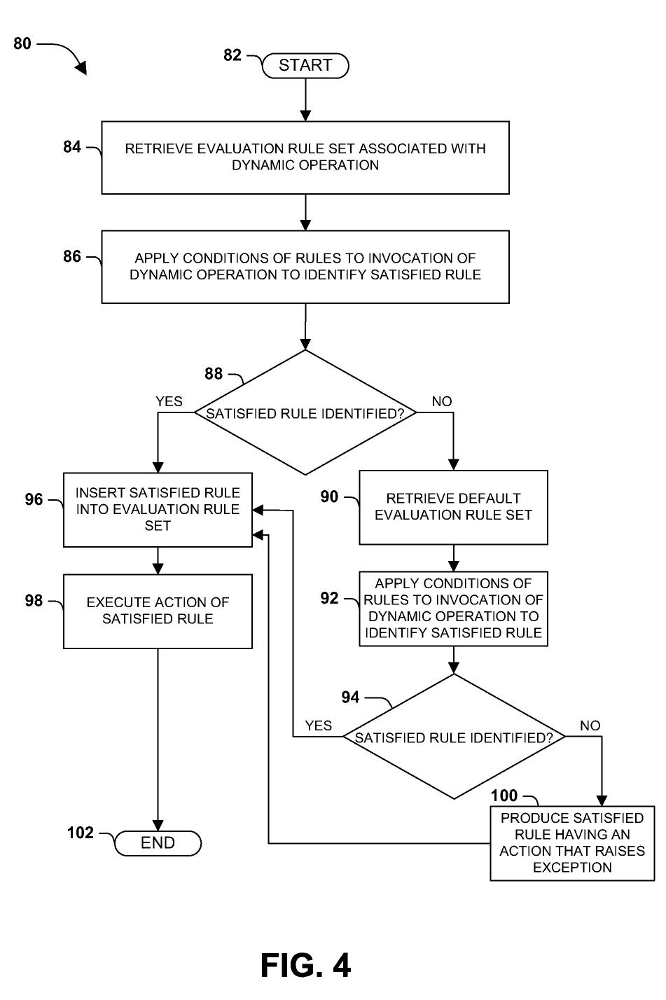

The techniques for evaluating a dynamic operation according to an evaluation rule set, such as illustrated in FIGS. 2-3, may be actualized in many embodiments. FIG. 4 presents one such embodiment, comprising an exemplary method 80 of executing an invocation of a dynamic operation specifying at least zero parameters. The exemplary method 80 begins at 82 and involves retrieving 84 an evaluation rule set associated with the dynamic operation, where the evaluation rule set comprising at least zero rules, and where respective rules comprising at least zero conditions and an action. (An evaluation rule set having zero rules is simply an empty evaluation rule set, which may be populated with rules upon further evaluation; and a rule with zero conditions is a default rule that is always satisfied, such as a catch-all rule.) The exemplary method 80 also involves applying 86 the conditions of the rules of the evaluation rule set to the invocation of the dynamic operation with the parameters to identify a satisfied rule. If the applying 86 of the rules of the evaluation rule set does not result in the identification of a satisfied rule, then the exemplary method 80 branches at 88 and involves retrieving 90 a default evaluation rule set, again comprising at least zero rules, respective rules comprising at least zero conditions and an action. The exemplary method 80 then involves applying 94 the conditions of the rules of the default evaluation rule set to the invocation of the dynamic operation with the parameters to identify a satisfied rule. If the default evaluation rule set also does not contain a rule that can be satisfied for the invocation, then the exemplary method 80 may be configured in various ways to handle a failure to identify a satisfied rule. As one example, and as shown here, the exemplary method 80 may also configured to produce 100 a satisfied rule that has an action that raises an exception. The exemplary method 80 may then continue with the processing of the exception-raising rule as the satisfied rule. Once a satisfied rule has been identified for a particular invocation of the dynamic operation, the exemplary method 80 involves inserting 96 the satisfied rule into the evaluation rule set and executing 98 the action of the satisfied rule. Having performed the dynamic operation with the appropriate action while also updating the evaluation rule set with the satisfied rule, the exemplary method 80 facilitates the performance of the dynamic operation for subsequent invocations, and so ends at 102.

It may be appreciated that the exemplary evaluation rule set utilized in FIG. 4 associated with a particular instance of a dynamic operation may initially be empty, i.e., may initially include no rules. The first invocation of the dynamic operation may therefore result in the lengthy evaluation of the dynamic operation according to a default evaluation rule set, which may include a large set of rules for evaluating every valid context of the dynamic operation. Upon identifying a satisfied rule in the default evaluation rule set, the exemplary method 80 of FIG. 4 results in the insertion of the rule into the evaluation rule set, so that the second invocation of the same dynamic operation results first in an evaluation of the rule that was satisfied during the first invocation. If the second invocation involves a different context for the dynamic operation that does not satisfy the first rule, then the default evaluation rule set may again be consulted, and upon identifying a rule of the default evaluation rule set that is satisfied during the second invocation of the dynamic operation, the second satisfied rule may also be inserted into the evaluation rule set. The third invocation of the same dynamic operation therefore begins with an evaluation of the evaluation rule set containing both of the rules that were previously satisfied, and so on. According to this technique, the evaluation rule set is populated with the rules that may be most likely to satisfy a subsequent invocation of the dynamic operation, in light of past successes in the satisfaction of such rules in prior invocations.

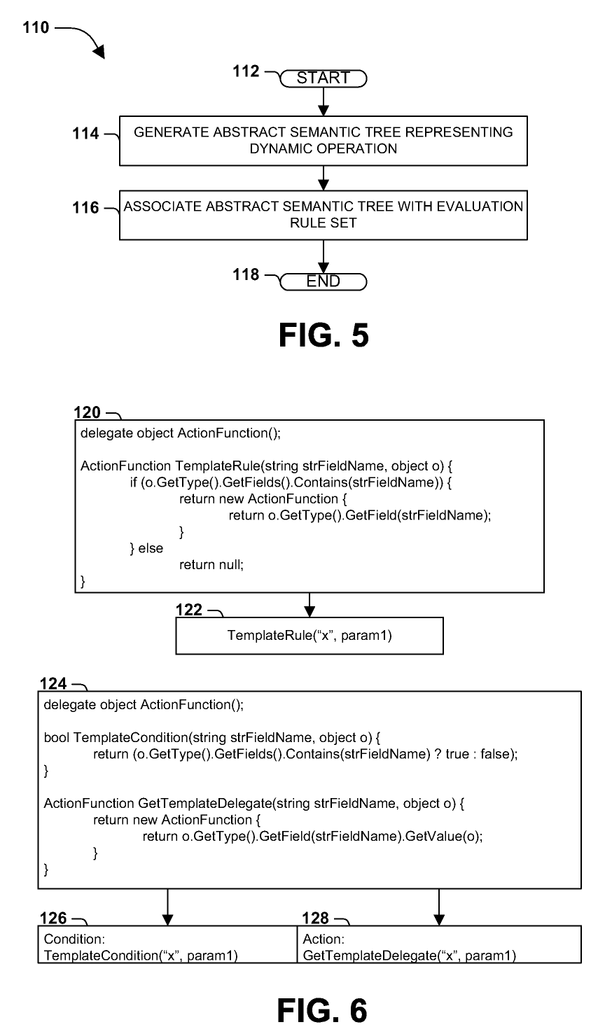

Instead of initiating the evaluation rule set for the dynamic operation during its first invocation, an evaluation rule set may be associated with the dynamic operation during the building of the application. FIG. 5 illustrates a second embodiment of these techniques relating to this aspect, comprising an exemplary method 110 of representing a dynamic operation. The exemplary method 110 begins at 112 and involves generating 114 an abstract semantic tree representing the dynamic operation, such as the abstract semantic tree 18 of FIG. 1. The exemplary method 110 also involves associating 116 the abstract semantic tree with an evaluation rule set comprising at least zero rules, where respective rules comprise at least zero conditions and an action. Having coupled the dynamic operation with an evaluation rule set, the exemplary method 110 thereby represents of the dynamic rule in a manner that facilitates its evaluation during successive invocations at runtime, and so ends at 118. Methods such as this exemplary method 110 may be useful for permitting a developer to specify during design time the likely rules by which a dynamic operation is most efficiently evaluated, i.e., the circumstances under which programmer anticipates the dynamic operation being invoked. The dynamic operation represented according to the exemplary method 110 of FIG. 5 thereby permits the specification of an evaluation rule set by the programmer, while also incorporating the flexibility of the adjustment of the evaluation rule set according to the exemplary method 80 of FIG. 4 for more robust and even more efficient evaluation of the evaluation rule set during runtime.

The techniques discussed herein may be implemented with variations in many aspects, wherein some variations may present additional advantages and/or reduce disadvantages with respect to other variations of these and other techniques. Such variations may be compatible with various embodiments of the techniques, such as the exemplary method 80 of executing a dynamic instruction illustrated in FIG. 4 and the exemplary method 110 of representing a dynamic instruction illustrated in FIG. 5, to confer such additional advantages and/or mitigate disadvantages of such embodiments.

A first aspect that may vary among implementations relates to the dynamic operation. The techniques for evaluating the dynamic operation according to an evaluation rule set may be applied to a dynamic operation included in an abstract semantic tree, and these structures may take many forms. As a first example, the program may simply be stored as uncompiled source code, such as a script. Upon invocation of the script, an interpreter may translate the program into an abstract semantic tree, which may be interpretively executed or partially or wholly compiled into low-level or machine instructions that can be directly executed. Upon encountering a dynamic operation in either the abstract semantic tree or the compiled executable at runtime, the computer system may associate the dynamic operation with an evaluation rule set, which may be populated with rules during successive invocations of the dynamic operation over the course of the program execution. As a second example, the program may be translated into an abstract semantic tree that is stored in an interpretable format, such as a serialized binary tree representation of the abstract semantic tree. An interpreter may then be invoked to interpretively execute the XML representation of the abstract semantic tree, and when the interpreter encounters the dynamic operation as a node of the abstract semantic tree, the interpreter may utilize an evaluation rule set to determine the proper execution of the dynamic operation at the moment of invocation during runtime. As a third example, the program may be translated into an abstract semantic tree that is wholly or partially compiled into machine instructions or a low-level language, which results in the generation of a compiled dynamic operation. The compiled dynamic operation may be associated with an evaluation rule set to be used in analyzing an invocation of the dynamic operation at runtime. Those of ordinary skill in the art may be able to utilize the techniques discussed herein in many scenarios involving the translation of a computer program to an abstract semantic tree having a dynamic operation and the subsequent execution of the computer program.

A second aspect that may vary among implementations relates to the structure and contents of the evaluation rule set associated with a dynamic operation. As a first example, the conditions of the rules may be specified in an abstract format that may be interpreted in evaluating the conditions of a rule (e.g., a rule comprising the string “param1<4”, which the computer system may parse during the dynamic operation evaluation in order to formulate a condition that may be applied to the parameters of the invocation.) A set of such rules may also be specified, and the rules may be connected in various manners, such as with Boolean logic (e.g., “(param1=int and param1<2) or (param1=float and param1<1.5)”) or a scoring system (e.g., “at least two of the following four conditions: . . . ”) Alternatively, the conditions of the rules may comprise a method associated with the dynamic operation and configured to test the invocation of the dynamic operation with the parameters according to the conditions of the rules of the evaluation rule set and to return the action of the satisfied rule. For instance, the rule may comprise a delegate pair, wherein the first delegate specifies a function accepting the parameters of the invocation and returns a Boolean value indicating whether or not the conditions were satisfied, and the second delegate specifies a function to be invoked as the action of the satisfied rule by which the dynamic operation is to be executed. Representing the conditions as a method may permit the rule to specify a broad and sophisticated set of conditions. The conditions may also be adjusted during runtime by emitting a new function comprising a revised method, and by referencing the method as the delegate for the conditions of the updated rule. Those of ordinary skill in the art may be able to devise many representations of the conditions of the rules of an evaluation rule set in accordance with the techniques discussed herein.

A second variation of the structure and contents of the evaluation rule set, which may be advantageous where the conditions and actions of the rules are embodied as delegates, relates to the languages used to specify such delegates and to manage the parameters provided in the invocation. Some development environments may not only support multiple programming languages, but may permit cross-language operations, such as adding an object of a first programming language and an object of a second programming language, or of applying an operation in a first language to an object of a second language. The dynamic operation may be applied in such mixed-language circumstances. This application may involve some cross-language translation, e.g., translating a 32-bit primitive integer used in a first language into a 64-bit primitive integer accepted as a parameter of an operation of a second language, but the details of these techniques may be applied without significant hindrance. For instance, where the conditions of the evaluation rule set are specified as methods, an evaluation rule set may comprise a first rule having at least one condition of a first language, and a second rule having at least one condition of a second language. The computer system may evaluate the conditions of either rule by executing the method through the corresponding language runtime for the condition method, and the evaluation results may be compared in a language-independent manner. Those of ordinary skill in the art may be able to devise many applications in mixed-language computer programs of the techniques discussed herein.

A third variation of the aspect relating to the structure and contents of the evaluation rule set relates to the manner of deriving the conditions and the action to be performed for a satisfied rule. As a first example, the conditions and associated actions of the rules may be predefined, such as those embodied in a default evaluation rule set that may be inserted into an evaluation rule set associated with a particular dynamic operation. As a second example, a user (such as a developer) may provide a user-defined rule, comprising a set of user-defined conditions (such as a method configured to test the conditions) and/or a user-defined action (such as a method referenced as the action delegate of the rule.) This example features a pluggable aspect of the evaluation rule set, wherein a developer may acknowledge the dynamic nature of a dynamic operation, and may provide one or more rules for evaluating an invocation of the dynamic operation based on the most likely circumstances in which the method may be invoked. For instance, a developer may specify that an add operation performed on two unspecified parameters is likely to be invoked as a string concatenate operation by providing a rule (to be evaluated first in the evaluation rule set) with conditions specifying that at least the first operand is a string, and a method delegated as the action of the rule comprising the instruction: “((string)param1).Concatenate(param1.ToString( ))”. Such a method may be explicitly declared by the user, or may be designated as an anonymous method, and inserted into the evaluation rule set as a first-class object according to a code-as-data methodology.

As a fourth example of the third variation of this aspect, one or more rules of the evaluation rule set may be based on a rule template, which may be formulated as a meta-rule to be applied to the circumstances of a particular dynamic operation. The specification of the rules according to a rule template may serve to apply a similar evaluation of similar dynamic operations, and may reduce some unnecessary duplication of rules. FIG. 6 illustrates two such examples, each comprising a template for a rule that tests whether an object contains a field having a particular name, and an action that returns the field. The first exemplary rule template 120 accepts an object of some kind and a string specifying the name of the field. If the condition succeeds, then the rule has been satisfied, and the first exemplary rule template 120 returns a parameterless delegate, comprising an anonymous method that returns the specified field from the specified object. This delegate can then be used as the action of the rule. If the condition fails, the first exemplary rule template 120 returns null to indicate that the rule is not satisfied. An exemplary application 122 of the first exemplary rule template 120 might be specified as a rule in an evaluation rule set that attempts to fetch a field named “x” from the first parameter provided in the dynamic operation. This exemplary application 122 results in a use of the first exemplary rule template 120 that returns either a parameterless delegate that fetches and returns the field named “x” from the first parameter, or a null reference if the condition fails (i.e., if the first parameter does not contain a field named “x”.) The second exemplary rule template 124 is similarly configured, but this template factors the functionality as a condition rule template (“TemplateCondition”) that returns a Boolean value indicating whether or not the rule was satisfied, and an action that returns an anonymous, parameterless method delegated to return the specified field of the specified object. The second exemplary rule template 124 may be similarly applied as an applied condition 126 that tests whether the first parameter of the dynamic operation contains a field named “x”, and an applied action 128 that generates a delegate that returns field “x” from the first parameter.

Upon building the application, the computer system may interpret this attribute by applying the rule template 124 to the dynamic operation, and by inserting into the evaluation rule set one or more rules generated by the application of the template. In this context, generating the evaluation rule set may comprise inserting into the evaluation rule set one or more applied rules based on the rule template and the dynamic operation. Alternatively, the computer system may store the template rule in the evaluation rule set, and the evaluation rule set may comprise at least one rule specified according to a rule template. Upon applying the evaluation rule set to the dynamic operation (such as upon encountering an invocation at runtime), the rule template may be applied to the dynamic operation to generate rules that may be applied in the evaluation. This example may benefit by reducing the duplication of such rules among many evaluation rule sets; e.g., if a program involves fifty instances of “param1+param2” dynamic operations, it may be more efficient to store a reference to a rule template in the evaluation rule set associated with dynamic operation than the fully expanded set of rules. Thus, the use of templates may provide a space-saving aspect, albeit at the modest expense of applying the rule template to the dynamic operation during runtime. Those of ordinary skill in the art may be able to devise many ways of utilizing rule templates in specifying the rules of the evaluation rule set while implementing the techniques discussed herein.

A third aspect that may vary among implementations of these techniques relates to the manner of evaluating the evaluation rule set. As one example, the evaluation rule set may be initially provided as an empty evaluation rule set. For instance, an empty evaluation rule set object may be associated with the dynamic operation during building; or the dynamic operation may initially not be associated with an evaluation rule set (e.g., a null reference), but upon failing to retrieve a rule set associated with the dynamic operation during the first invocation, the dynamic operation may be associated with a new evaluation rule set. Alternatively, the evaluation rule set may be initially generated with some or all of the rules of the default evaluation rule set, which may be reconfigured for improved efficiency upon successive invocations of the dynamic operation. As a second alternative, the evaluation rule set may be populated by the user, such as a developer, with one or more rules specified at design time.

Another example of variations in the processing of the evaluation rule set relates to the order of evaluation of the rules. For instance, the evaluation rule set may comprise an unordered set of rules, and the computer system may apply the conditions of the rules of the evaluation rule set to the invocation of the dynamic operation with the parameters in parallel, or in an arbitrary order, to determine a satisfied rule. This evaluation ordering may suffice if the rules are mutually exclusive, i.e., if the conditions specifying one rule may only be satisfied if the other rules cannot be satisfied for a particular invocation. For example, the conditions of rules may all relate to an analysis of primitive types of the objects, which may exhibit mutual exclusivity when applied to invocations of dynamic operations written in a language with strong and invariant typing.

As a first alternative organization of the rules of the evaluation rule set, the rules may be organized in a series, and the conditions of the rules of the evaluation rule set to the invocation of the dynamic operation with the parameters may be applied in a serial rule evaluation. The first rule may be evaluated first, and if the conditions of the first rule are satisfied, the evaluation may end and the action associated with the first rule may be utilized to execute the dynamic operation. If the first rule is not satisfied, then the second rule may be next evaluated, and if the conditions of the second rule are satisfied, the evaluation may end and the action associated with the second rule may be utilized to execute the dynamic operation. If the second rule is also not satisfied, then the serial evaluation may continue through the remaining rules of the evaluation rule set. A serial evaluation may be advantageous for permitting a simple reconfiguration of the evaluation rule set for improved efficiency by moving a satisfied rule to the beginning (or near the beginning) of the series, thereby prompting an earlier evaluation of the satisfied rule during the next invocation of the dynamic operation.

As a second alternative organization of the rules of the evaluation rule set, the rules may be organized according to a conditional hierarchy, and the evaluation may involve applying the conditions of the rules of the evaluation rule set to the invocation of the dynamic operation with the parameters according to the conditional hierarchy of the evaluation rule set. This ordering may be additionally efficient providing a log(n) process of condition evaluation, such that a condition that is included in several rules and mutually excluded from several other rules (e.g., “param1 is some kind of numeric type”) may be evaluated once, and the rules contrary to the result of the evaluation may be excluded from the evaluation. The hierarchical ordering of the rules may also permit more sophisticated specification of the conditions of the evaluation rule set, which may first implement some general tests of the circumstances pertinent to the dynamic operation invocation before applying more specific conditions (e.g., “is parameter 1 a primitive type? if not, is parameter 1 a type of user interface control? If so, is parameter 1 a type of button?”) Those of ordinary skill in the art may be able to devise many such organizational schemas for the evaluation rule set while implementing the techniques discussed herein.

A fourth aspect that may vary among implementations of these techniques relates to the configuration of the default evaluation rule set. As one example, the default evaluation rule set may automatically reflect on the accessible methods having the name of the dynamic operation, may compare the parameters by type with the parameters of each such available method, and may select a method configured to accept the parameters provided with the invocation. Each considered method may comprise an action of a rule, with the conditions of accepting the number and types of parameters provided with the invocation. An identified method may then be represented as the action of a satisfied rule, which may be generated and inserted into the evaluation rule set associated with the dynamic operation. As another example, the default evaluation rule set may include rules requesting one or more of the objects provided as parameters to provide a suitable action for performing the dynamic operation. For instance, if a “+” dynamic operation is invoked with a first parameter comprising a string and a second parameter comprising some object type, the default evaluation rule set may instruct the computer system to inquire with the String class for an appropriate method of performing a “+” on a string with the second parameter. Alternatively or additionally, the default evaluation rule set may include rules requesting a runtime that is managing one or more of the parameters to provide a suitable action for performing the dynamic operation. For instance, if the string specified in the “+” dynamic operation is managed by a C# runtime, the default evaluation rule set may instruct the computer system to inquire of the C# runtime to delegate a method for performing the “+” dynamic operation on its parameter of type string with the second parameter. Those of ordinary skill in the art may be able to devise many such default evaluation rule sets while implementing the techniques discussed herein.

A fifth aspect that may vary among implementations of these techniques relates to the reconfiguration of the evaluation rule set upon identifying a satisfied rule. As a first variation, if the evaluation rule set is embodied as a compiled method, an updated method may be compiled (e.g., by reflection emit) that includes the satisfied rule, and may be associated with the dynamic operation. The satisfied rule may be newly generated, selected from the default evaluation rule set, relocated within the evaluation rule set (e.g., by moving the order of evaluation of the satisfied rule earlier in the evaluation method), etc. If the evaluation rule set is organized according to a conditional hierarchy, then the inserted rule may comprise the action of the satisfied rule along with all of the conditional rules satisfied while navigating the conditional hierarchy to reach the node of the satisfied rule. For instance, if a satisfied rule is organized in a conditional hierarchy featuring a first condition (condition: “is param1 a primitive type?” answer: true) and a second condition (condition: “is param1 a string?” answer: true), and if the satisfied rule comprises the condition “param1.length<4”, then the rule inserted into the evaluation rule set may comprise all three conditions (“param1 is a primitive type, and param1 is a string, and param1.length<4”) and the action associated with the satisfied rule.

As a second variation of the aspect involving the reconfiguration of the evaluation rule set, the rule set may be devised as a serially monomorphic evaluation rule set. In this variation, the evaluation rule set comprises only a small number of rules, such as one rule comprising the rule satisfied during the most recent invocation of the dynamic operation. If the rule is not satisfied during a subsequent invocation of the dynamic operation, then the default evaluation rule set may be consulted to identify a satisfied rule, and the dynamic operation may be associated with a new evaluation rule set comprising the satisfied rule as one of a few rules, or as the only rule of the evaluation rule set. This variation may be useful where a high degree of confidence exists that the dynamic operation is likely to be invoked repeatedly under circumstances satisfying a particular rule, such as with parameters of a particular type, and that rules that were useful in analyzing prior invocations may not be as useful for subsequent invocations. The restriction of the evaluation rule set to a single rule may therefore economize computing resources by maintaining small evaluation rule sets for various dynamic operations. If a previous rule that has been removed from the evaluation rule set is never later satisfied, then the evaluation rule set stays as a monomorphic evaluation rule set comprising only the newest, most recent rule found for the operation. Alternatively, if a dynamic operation is found to satisfy various rules in different invocations, then the monomorphic nature of the evaluation rule set may be discarded, and the evaluation rule set may be allowed to comprise multiple rules to handle the varying invocations of the dynamic operation.

As a third variation of the aspect involving the reconfiguration of the evaluation rule set, the conditions of the rules comprising the rule set may be compared during the reconfiguration to reduce redundant condition testing. If rules are frequently inserted into the evaluation rule set having multiple conditions, then a condition may be retested several times for a particular invocation of the dynamic operation while evaluating several rules. For instance, multiple rules may begin with the condition “param1 is not null,” and it may be inefficient to test this condition upon evaluating several of the rules. Instead, when an evaluation rule set organized as a conditional hierarchy is reconfigured, the computer system may attempt to detect whether a condition present in at least two rules. If so, the condition may be inserted in the evaluation rule set as a parent node of the at least two rules, and may be removed from each of the rules. Reconfiguring the evaluation rule set to group rules according to shared conditions may result in a sophisticated and efficient evaluation rule set that differentially evaluates the rules according to shared conditions.

As a fourth variation of the aspect involving the reconfiguration of the evaluation rule set, the rule set may be devised to eliminate rules that may no longer be satisfied for future invocations of the evaluation rule set. For instance, a computer program may feature an integer that is only incremented (i.e., neither decremented nor reset) during the execution of the program, such as a system uptime timer. A rule may comprise a condition that may be invoked if the integer is below a certain threshold value. If the integer ever exceeds the value, the condition of the rule cannot be satisfied during the continued execution of the program. In this instance, the computer system may determine that the rule can no longer be satisfied for subsequent evaluations of the dynamic operation, and the computer system may remove the rule from the evaluation rule set. This variation may be implemented (e.g.) as a mechanism by which a delegate comprising a method evaluation of a condition may request the cancellation of the rule, in case the method determines that the condition can no longer be satisfied. Those of ordinary skill in the art may devise many variations in the reconfiguration of the evaluation rule set upon identifying a satisfied rule while implementing the techniques discussed herein.

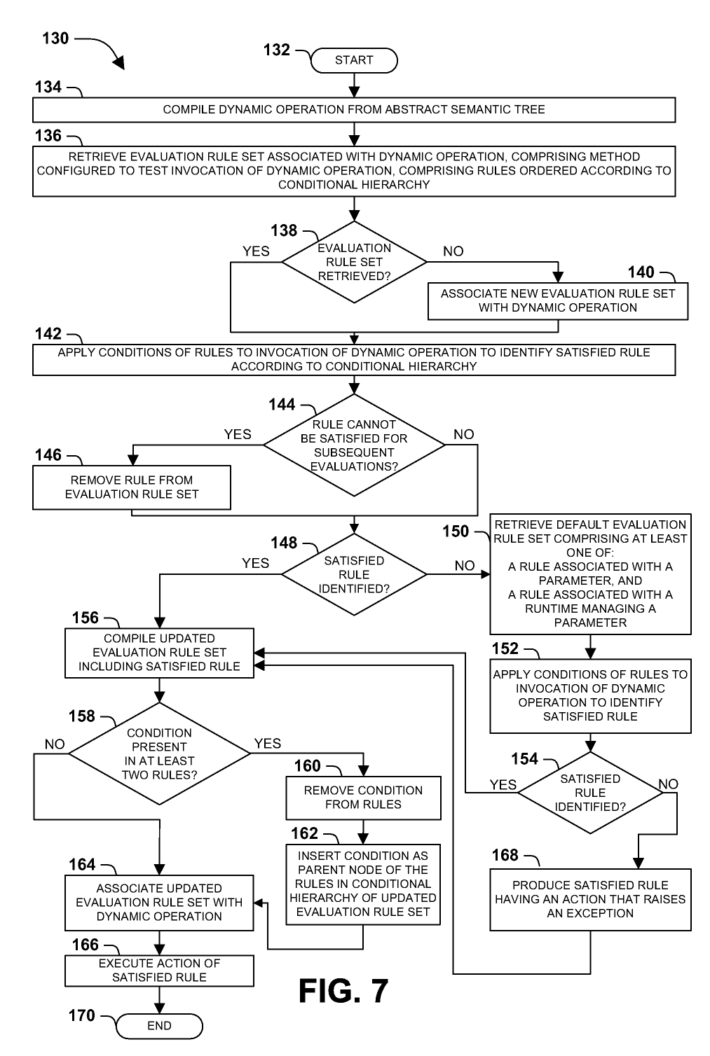

The variations of the aspects discussed herein may be mutually compatible, and several variations may be included in an embodiment to achieve numerous advantages and/or reductions in disadvantages with respect to other embodiments. FIG. 7 illustrates one such embodiment that includes several of the advantageous variations discussed herein, comprising an exemplary method 130 of executing an invocation of a dynamic operation represented by an abstract semantic tree, where the invocation may specify one or more parameters.

The exemplary method 130 of FIG. 7 begins at 132 and involves compiling 134 a dynamic operation from the abstract semantic tree. The exemplary method 130 also involves retrieving 136 an evaluation rule set associated with the dynamic operation, where the evaluation rule set comprising a method configured to test the invocation of the dynamic operation with the parameters according to at least zero rules, where each rule comprises zero or more conditions and an action. The evaluation rule set utilized in this exemplary method 130 is also ordered according to a conditional hierarchy, which may be advantageous in streamlining the evaluation of the rules. If the exemplary method 130 fails to retrieve a rule set associated with the dynamic operation, the exemplary method 130 branches at 138 and associates 140 a new evaluation rule set with the dynamic operation, which may be used in the further evaluation of the invocation of the dynamic operation.

Having retrieved an evaluation rule set associated with the dynamic operation, the exemplary method 130 involves applying 142 the conditions of the rules of the evaluation rule set to the invocation of the dynamic operation with the parameters according to the conditional hierarchy of the evaluation rule set. If, during the evaluation of the rules of the evaluation rule set, the exemplary method 130 detects a rule of the evaluation rule set that cannot be satisfied for subsequent evaluations of the dynamic operation, the exemplary method 130 branches at 144 and involves removing 146 the rule from the evaluation rule set.

The exemplary method 130 continues by attempting to identify a satisfied rule while applying 142 the conditions of the rules to the invocation of the dynamic operation. If the exemplary method 130 fails to identify a satisfied rule, then the exemplary method 130 branches at 148 and involves retrieving 150 a default evaluation rule set, which may comprise at least one of a rule associated with a parameter of the invocation of the dynamic operation, and a rule associated with a runtime managing a parameter of the invocation of the dynamic operation. The exemplary method 130 then involves applying 152 the conditions of the rules of the default evaluation rule set to the invocation of the dynamic operation with the parameters to identify a satisfied rule. If a satisfied rule is identified while applying 152 the rules of the default evaluation rule set, the exemplary method 130 branches at 154 and rejoins the method as if the satisfied rule were identified at 148. If the exemplary method 130 fails to identify a suitable rule in either the evaluation rule set or the default evaluation rule set, the exemplary method 130 involves producing 168 a satisfied rule having an action that raises an exception.

Once the exemplary method 130 succeeds in identifying a satisfied rule at 148 or 154, the exemplary method 130 proceeds by acting upon the satisfied rule and reconfiguring the evaluation rule set. First, the exemplary method 130 involves compiling 156 an updated evaluation rule set including the satisfied rule. If, during the compiling 156, the exemplary method 130 detects a condition present in at least two rules, the exemplary method 130 branches at 158 and involves removing 160 the condition from the at least two rules, and inserting 162 the condition as a parent node of the at least two rules in the conditional hierarchy of the updated evaluation rule set. The exemplary method 130 proceeds by associating 164 the updated evaluation rule set with the dynamic operation, executing 166 the action of the satisfied rule. Having achieved the execution of an action suitable for the invocation of the dynamic operation according to the conditions of the evaluation rule set, the exemplary method 130 achieves the performance of the dynamic operation while updating the evaluation rule set for improved evaluation, and so ends at 170. Many such embodiments featuring multiple variations in several aspects may be devised by those of ordinary skill in the art while practicing the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of executing an invocation of a dynamic operation specifying at least zero parameters, the method comprising:
retrieving an evaluation rule set associated with the dynamic operation, the evaluation rule set comprising at least zero rules, respective rules comprising at least zero conditions and an action;
applying the conditions of the rules of the evaluation rule set to the invocation of the dynamic operation with the parameters to identify a satisfied rule;
upon failing to identify a satisfied rule in the evaluation rule set:
retrieving a default evaluation rule set, and
applying the conditions of the rules of the default evaluation rule set to the invocation of the dynamic operation with the parameters to identify a satisfied rule; and
upon identifying a satisfied rule:
inserting the satisfied rule into the evaluation rule set, and
executing the action of the satisfied rule.

2. The method of claim 1, comprising:
compiling the dynamic operation from an abstract semantic tree.

3. The method of claim 1, the evaluation rule set comprising at least one user-defined rule comprising at least zero user-defined condition and a user-defined action.

4. The method of claim 1, the evaluation rule set comprising:
a first rule having at least one condition of a first language, and
a second rule having at least one condition of a second language.

5. The method of claim 1, the evaluation rule set comprising at least one rule specified according to a rule template.

6. The method of claim 1, comprising:
upon failing to retrieve a rule set associated with the dynamic operation, associating a new evaluation rule set with the dynamic operation.

7. The method of claim 1, the applying comprising: applying the conditions of the rules of the evaluation rule set to the invocation of the dynamic operation with the parameters in one of a serial rule evaluation, an arbitrarily ordered rule evaluation, and a parallel rule evaluation.

8. The method of claim 1:
the rules of the evaluation rule set ordered according to a conditional hierarchy, and
the applying comprising: applying the conditions of the rules of the evaluation rule set to the invocation of the dynamic operation with the parameters according to the conditional hierarchy of the evaluation rule set.

9. The method of claim 8, the inserting comprising:
upon detecting a condition present in at least two rules:
inserting the condition as a parent node of the at least two rules in the conditional hierarchy of the evaluation rule set, and
removing the condition from the at least two rules.

10. The method of claim 1, the default evaluation rule set comprising at least one of:
a rule associated with a parameter of the invocation of the dynamic operation, and
a rule associated with a runtime managing a parameter of the invocation of the dynamic operation.

11. The method of claim 1, the evaluation rule set comprising a method associated with the dynamic operation and configured to test the invocation of the dynamic operation with the parameters according to the conditions of the rules of the evaluation rule set and to return the action of the satisfied rule.

12. The method of claim 11, the inserting comprising:
compiling an updated method including the satisfied rule, and
associating the updated method with the dynamic operation.

13. The method of claim 1, the inserting comprising: associating with the dynamic operation an evaluation rule set comprising a rule comprising the conditions satisfied by the satisfied rule and the action of the satisfied rule.

14. The method of claim 1, comprising:
upon detecting a rule of the evaluation rule set that cannot be satisfied for subsequent evaluations of the dynamic operation, removing the rule from the evaluation rule set.

15. The method of claim 1, comprising:
upon failing to identify a satisfied rule in the evaluation rule set and the default evaluation rule set, producing a satisfied rule having an action that raises an exception.

16. A method of representing a dynamic operation, the method comprising:
generating an abstract semantic tree representing the dynamic operation, and
associating the abstract semantic tree with an evaluation rule set comprising at least zero rules, respective rules comprising at least zero conditions and an action.

17. The method of claim 16, comprising:
compiling the abstract semantic tree to generate a compiled dynamic operation.

18. The method of claim 16, comprising:
accepting a user-defined rule comprising at least one user-defined condition and a user-defined action, and
inserting the user-defined rule into the evaluation rule set associated with the abstract semantic tree.

19. The method of claim 16:
the evaluation rule set comprising at least one rule specified according to a rule template, and
the generating comprising:
for respective rules in the evaluation rule set specified according to a rule template, inserting into the evaluation rule set an applied rule based on the rule template and the dynamic operation.

20. A method of executing an invocation of a dynamic operation represented by an abstract semantic tree, the invocation specifying at least zero parameters, and the method comprising:
compiling a dynamic operation from the abstract semantic tree;
retrieving an evaluation rule set associated with the dynamic operation, the evaluation rule set comprising a method configured to test the invocation of the dynamic operation with the parameters according to at least zero rules, respective rules comprising at least zero conditions and an action, and the rules of the evaluation rule set ordered according to a conditional hierarchy;
upon failing to retrieve a rule set associated with the dynamic operation, associating a new evaluation rule set with the dynamic operation;
applying the conditions of the rules of the evaluation rule set to the invocation of the dynamic operation with the parameters according to the conditional hierarchy of the evaluation rule set;
upon detecting a rule of the evaluation rule set that cannot be satisfied for subsequent evaluations of the dynamic operation, removing the rule from the evaluation rule set;
upon failing to identify a satisfied rule in the evaluation rule set:
retrieving a default evaluation rule set comprising at least one of:
a rule associated with a parameter of the invocation of the dynamic operation, and
a rule associated with a runtime managing a parameter of the invocation of the dynamic operation;
applying the conditions of the rules of the default evaluation rule set to the invocation of the dynamic operation with the parameters to identify a satisfied rule; and
upon failing to identify a satisfied rule in the default evaluation rule set, producing a satisfied rule having an action that raises an exception; and
upon identifying a satisfied rule:
compiling an updated evaluation rule set including the satisfied rule;
upon detecting a condition present in at least two rules:
inserting the condition as a parent node of the at least two rules in the conditional hierarchy of the updated evaluation rule set, and
removing the condition from the at least two rules;
associating the updated evaluation rule set with the dynamic operation; and
executing the action of the satisfied rule.
